(19) United States
(12) Patent Application Publication
(10) Pub. No.: US 2012/0143593 A1
(43) Pub. Date: Jun. 7, 2012

(54) FUZZY MATCHING AND SCORING BASED ON DIRECT ALIGNMENT

(75) Inventors: Enyuan Wu, Bellevue, WA (US); Alan K. Michael, Monroe, WA (US); Beom Seok Oh, Fall City, WA (US); Shusuke Uehara, Redmond, WA (US); Kevin S. O'Donnell, Kirkland, WA (US)

(73) Assignee: MICROSOFT CORPORATION, Redmond, WA (US)

(21) Appl. No.: 12/961,878

(22) Filed: Dec. 7, 2010

(51) Int. Cl. G06F 17/28

(52) U.S. Cl. 704/2

(57) ABSTRACT

Various embodiments provide a translation memory system that utilizes sentence-level fuzzy matching and a scoring algorithm based on direct alignment. In one or more embodiments, a fuzzy match scoring formula includes use of an edit operation definition to define various deductions that are computed as part of an overall score, an overall scoring algorithm, and word-level scoring and partial match definitions. A direct alignment algorithm finds a computed alignment between two sentences using a pair-wise difference matrix associated with a primary sentence and a comparison sentence. An overall algorithm identifies editing operations such as replacements, position swaps and adjustments for a final score calculation. Once final scores are calculated between the primary sentence and multiple comparison sentences, a primary/comparison sentence pair can be selected, based on the score, to serve as a basis for translating the primary sentence.

### BACKGROUND

Translation memory systems store translations that are typically produced by a human translator so that the translations can be re-used to reduce the cost of translations. Such systems can recognize not only exact matches with respect to source text, but also near or close matches as well.

As translation memory systems continue to advance, challenges exist to provide systems with improved efficiencies.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a translation memory system that utilizes sentence-level fuzzy matching and a scoring algorithm based on direct alignment. In one or more embodiments, a fuzzy match scoring formula includes use of an edit operation definition to define various deductions that are computed as part of an overall score, an overall scoring algorithm, and word-level scoring and partial match definitions. A direct alignment algorithm finds a computed alignment between two sentences using a pair-wise difference matrix associated with a primary sentence and a comparison sentence. An overall algorithm identifies editing operations such as replacements, position swaps and adjustments for a final score calculation. Once final scores are calculated between the primary sentence and multiple comparison sentences, a primary/comparison sentence pair can be selected, based on the score, to serve as a basis for translating the primary sentence.

### BRIEF DESCRIPTION OF THE DRAWINGS

The same numbers are used throughout the drawings to reference like features.

FIG. 1 is an illustration of an environment in an example implementation in accordance with one or more embodiments.

FIG. 2 describes high level aspects of an algorithm in accordance with one or more embodiments.

FIG. 3 illustrates a table that defines allowable character difference values for various partial matches in accordance with one or more embodiments.

FIG. 4 illustrates an example two-dimensional array in accordance with one or more embodiments.

FIG. 5 illustrates an example two-dimensional array in accordance with one or more embodiments.

FIG. 6 is a flow diagram that describes, at a high level, steps in a method in accordance with one or more embodiments.

FIG. 7 is a flow diagram that describes steps in a method in accordance with one or more embodiments.

FIG. 8 is a flow diagram that describes steps in a method in accordance with one or more embodiments.

FIG. 9 is a flow diagram that describes steps in a method in accordance with one or more embodiments.

FIG. 10 illustrates aspects of a direct alignment algorithm in accordance with one or more embodiments.

FIG. 11 illustrates aspects of a direct alignment algorithm in accordance with one or more embodiments.

FIG. 12 illustrates aspects of a direct alignment algorithm in accordance with one or more embodiments.

FIG. 13 illustrates an example system that can be used to implement one or more embodiments.

### DETAILED DESCRIPTION

Overview

Various embodiments provide a translation memory system that utilizes sentence-level fuzzy matching and a scoring algorithm based on direct alignment. In one or more embodiments, a fuzzy match scoring formula includes use of an edit operation definition to define various deductions that are computed as part of an overall score, an overall scoring algorithm, and word-level scoring and partial match definitions. A direct alignment algorithm finds a computed alignment between two sentences using a pair-wise difference matrix associated with a primary sentence and a comparison sentence. An overall algorithm identifies editing operations such as replacements, position swaps and adjustments for a final score calculation. Once final scores are calculated between the primary sentence and multiple comparison sentences, a primary/comparison sentence pair can be selected, based on the score, to serve as a basis for translating the primary sentence.

In the discussion below, a “comparison sentence” is a sentence in a language for which a translation to a different language exists. A “primary sentence” is a sentence that is compared to a comparison sentence for purposes of calculating a score. A primary sentence is typically compared to multiple comparison sentences for purposes of finding a desirable score-based match. The sentence pair (i.e. primary sentence/comparison sentence) with the highest score-based match is then selected. Once selected, the comparison sentence can be used to effect a translation of the primary sentence.

In the discussion that follows, a section entitled “Example Operating Environment” is provided and describes one operating environment in which one or more embodiments can be employed. Following this, a section entitled “Overall Sentence-Level Fuzzy Matching Algorithm—High Level” describes, at a high level, an example fuzzy matching/scoring algorithm. Next, a section entitled “Example Implementation” describes aspects of an example implementation in accordance with one or more embodiments. Various sub-sections within this section describe aspects of the inventive techniques. Last, a section entitled “Example System” describes an example system that can be used to implement one or more embodiments.

Consider now an example operating environment in which one or more embodiments can be implemented.

Example Operating Environment

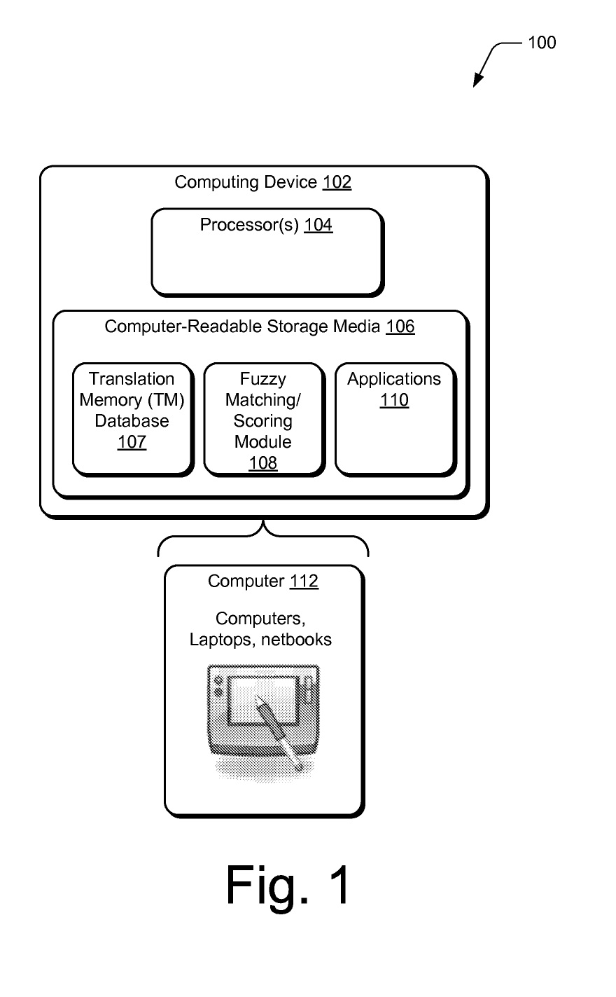

FIG. 1 illustrates an example operating environment in which the inventive sentence-level fuzzy matching and scoring algorithm can be employed in accordance with one or more embodiments.

Illustrated environment 100 includes computing device 102 having one or more processors 104 and one or more computer-readable storage media 106 that may be configured in a variety of ways. In one or more embodiments, computer-readable storage media 106 can include a translation memory database 107, fuzzy matching/scoring module 108 that can form part of a translation management system that operates as described above and below, as well as various applications 110.

The computing device 102 may assume any suitable form or class. For example, computing device 102 may assume a computer device class 112 that includes client devices, personal computers, laptop computers, netbooks, and so on. Thus, the techniques described herein may be supported by these various configurations of the computing device 102 and are not limited to the specific examples described in the following sections. The computing device 102 also includes software that causes the computing device 102 to perform one or more operations as described below.

The translation memory database 107 is configured to pre-select potential candidates (i.e. comparison sentences) using a full-text search mechanism. For example, Microsoft's SQL server database embodies such functionality. In this manner, the fuzzy matching/scoring module 108 operates on a very small set of high potential candidates.

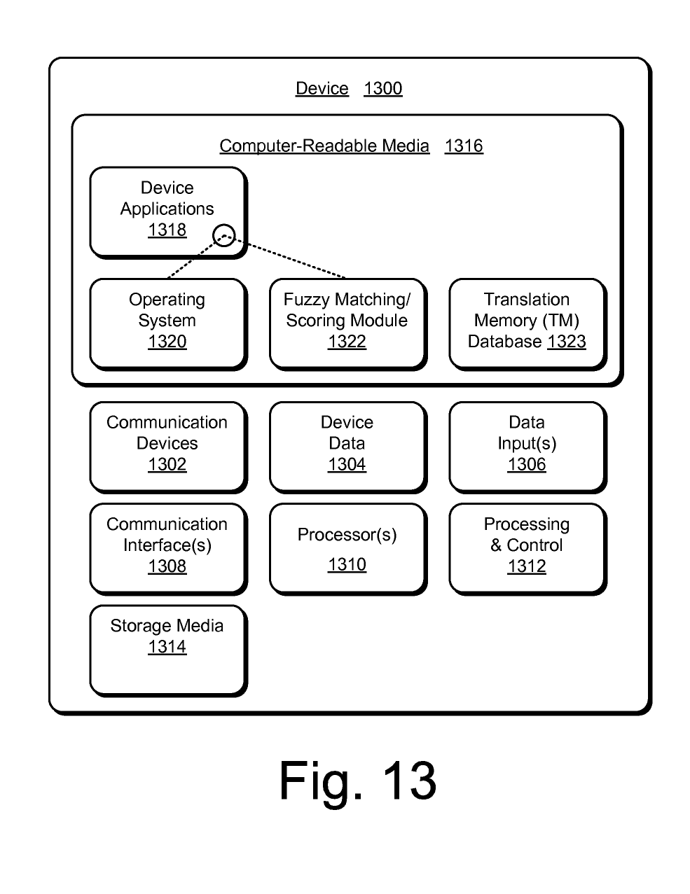

The fuzzy matching/scoring module 108 and applications 110 can be implemented in connection with any suitable type of hardware, software, firmware or combination thereof. In at least some embodiments, the fuzzy matching scoring module is implemented in software that resides on some type of tangible, computer-readable storage medium. The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 13.

Fuzzy matching/scoring module 108 is representative of functionality that utilizes a fuzzy match scoring formula that includes an edit operation definition, overall scoring algorithm, and word-level scoring and partial match definitions. The module 108 also employs a direct alignment algorithm to find a computed alignment between two sentences using a pair-wise difference matrix. In addition, the module 108 utilizes an overall algorithm that identifies editing operations such as replacements, position swaps and adjustments for a final score calculation which can form the basis of a selection to facilitate translation of a primary sentence, as described below.

Having described an example operating environment, consider now a high level discussion of the overall sentence-level fuzzy matching/scoring algorithm in accordance with one or more embodiments.

Overall Sentence-Level Fuzzy Matching Algorithm—High Level

The following description provides a high-level context for the discussion that follows. In this section, a high level discussion of the overall sentence-level fuzzy matching/scoring algorithm is provided. Following this section, various aspects of the algorithm are described in subsequent sections which map back to this overall high-level context.

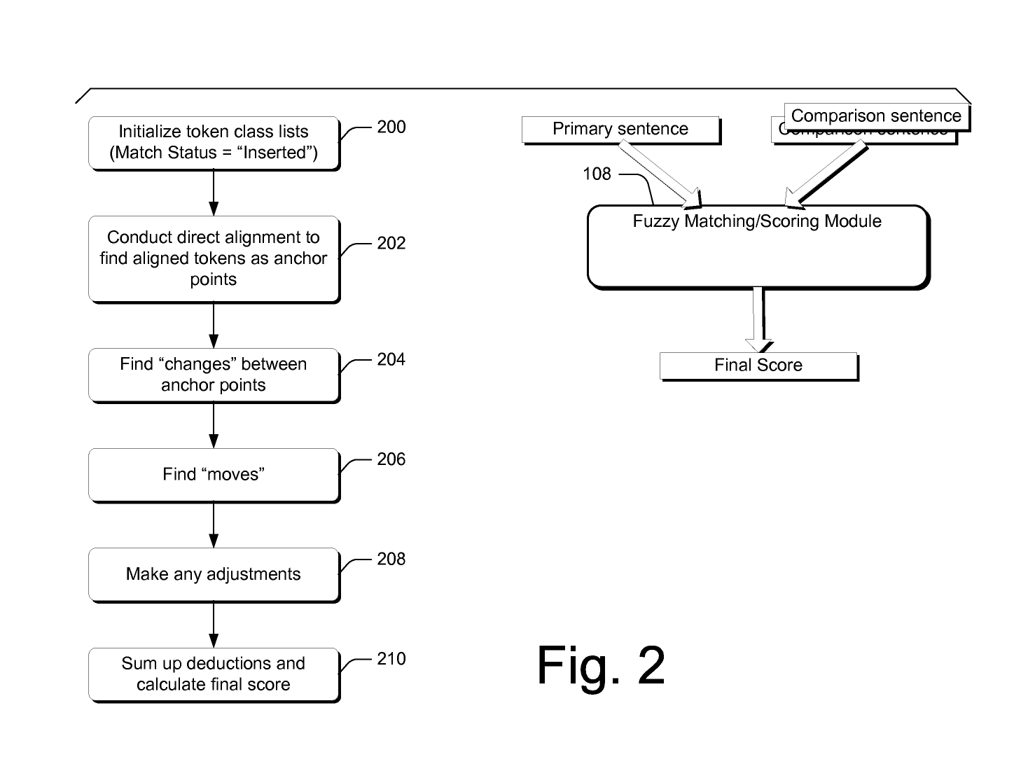

As illustrated in FIG. 2, the fuzzy matching/scoring module 108 receives, as input, one or more comparison sentences and a primary sentence. Comparison sentences constitute those sentences for which a translation exists in a translation memory database. A primary sentence constitutes a sentence for which a translation does not exist in the database, but for which a translation is desired. Hence, the comparison sentences are evaluated, as described below, to find a candidate that can be used to translate the primary sentence.

The module 108 analyzes both sentences, in accordance with the functionality described herein, to produce a final score. This final score is used and evaluated against other processed primary sentence/comparison sentence pairs to select a score that indicates a desirable translation, e.g., the comparison sentence with the highest score is selected as the candidate to serve to facilitate translation of the primary sentence. Alternately or additionally, multiple candidate comparison sentences can be selected and then further evaluated by a human translator. Thus, in the illustrated and described embodiment, those sentence pairs with lower scores are less desirable translation candidates than those sentence pairs with higher scores.

From a high level, functional standpoint, the flow diagram of FIG. 2 describes aspects of the algorithm that are implemented by module 108. Each of these aspects is described in more detail below. At step 200, a token class list is initialized, as described below in more detail. A token represents a language element such as a word or number. Token classes are used to maintain information associated with tokens as the algorithm is run on a primary/comparison sentence pair. At step 202, a direct alignment operation is conducted to find aligned tokens or anchor points. Again, this is explored in more detail below.

Next, step 204 finds “changes” between anchor points. Step 206 finds so-called “moves” and step 208 makes any adjustments. What is meant by these various steps will become clear when the description below as considered. In the illustrated and described embodiment, anchor points constitute tokens that are the same as between the primary and comparison sentence. So-called “changes,” “moves,” and adjustments constitute deductions that are accounted for when a final score is computed. Finally, step 210 sums up the various deductions and calculates the final score. As noted above, this final score is used to select a desirable translation candidate or candidates.

Having considered a high-level discussion of the fuzzy matching/scoring module 108 and its functionality, consider now a more detailed discussion that describes various aspects of this functionality.

Example Implementation

In the discussion that follows, three different sections describe an implementation example that incorporates aspects of a translation memory system.

First, a section entitled “Sentence-Level Scoring Scheme and Word-Level Score Calculation” describes a token type definition which defines various token types that are utilized by the fuzzy matching/scoring module. In addition, a discussion of an example sentence-level score formula as well as token-level scoring rules are discussed. These rules define how values are assigned to tokens which, in turn, contribute to the calculation of the overall score. Further, the notion of edit operations is introduced as well as a discussion of an example token class. Edit operations serve to reduce the overall score that is computed, as will become apparent below.

Next, a section entitled “Direct Alignment Algorithm” describes an alignment algorithm that is used in accordance with one or more embodiments. In this section the notion of a two-dimensional array is introduced as well as the concepts of horizontal, vertical, and single-pair groups. The two-dimensional array is used to store edit differences for token pairs as well as to find a “search direction” and identify the aligned pairs or anchor points.

Finally, a section entitled “Main Algorithm” describes how the information developed in the previous two sections is utilized to calculate a final score. The description in this section maps to the overall process described in steps 200-210 in FIG. 2 and such will be referenced during the description in the “Main Algorithm” section.

Sentence-Level Scoring Scheme and Word-Level Score Calculation

In the discussion that follows, several concepts are described and are later utilized to compute a score for a primary sentence and a corresponding comparison sentence. Recall that the outcome of the overall process will be a collection of scores for a primary sentence and respective comparison sentences. The pair (or pairs) with the highest score can then be selected and the corresponding comparison sentence(s) can be used to effect a translation of the primary sentence. That is, according to the formula, the pair or pairs with the highest score(s) is (are) associated with a comparison sentence or sentences that is (are) nearest of the other comparison sentences to the associated primary sentence. As such, the selected comparison sentence(s) constitutes a natural starting point for translating the primary sentence. This section describes some foundational aspects or building blocks which are utilized to compute an overall score.

For example, the discussion starts first with a description of a definition for a token type that is employed in the inventive approach described herein. It is to be appreciated and understood that the token type definition about to be described constitutes but one token type definition. Accordingly, other token type definitions can be utilized without departing from the spirit and scope of the claimed subject matter. Following this, a discussion of a sentence-level score formula and token-level scoring rules describes various parameters associated with computation of an overall score. Next, the notion of edit operations and how such impact the scoring process is described.

As will be appreciated by the skilled artisan, English sentences or phrases are sequences of various language elements called tokens. Tokens can take on many different forms or types, such as words and the like. For the scoring approach described in this document, the following token types are utilized:

| Token Type | Example or Definition |
|---|---|
| Word | A “word” is defined as an English word |
| | that is case-sensitive. |
| Tag | A tag is defined as an inline markup tag, |
| | normalized to one symbol “TAG” |
| | regardless of the details. |
| Number | A number is defined as numeric values, |
| | normalized to one symbol “####” |
| | regardless of the details. |
| Punctuation marks | Examples of punctuation marks include: . , ; : ! ? |
| Delimiter | Examples of delimiters include: \ / ″ ( ) { } [ ] - |

It should be noted that while the token type “word” is defined as an English word, such is not intended to limit word token types to only English words. Accordingly, a “word” could be defined in a language other than English without departing from the spirit and scope of the claimed subject matter. In addition, other different token types can be utilized without departing from the spirit and scope of the claimed subject matter.

Using these tokens and the processing described herein, a sentence-level score formula, described below in the section entitled “Main Algorithm,” is utilized to calculate a score for a sentence. In the illustrated and described embodiment, the following sentence-level score formula, which will be revisited below, can be utilized:

Overall score=(total token count−total deductions)/(total token count)

In this example, the “total token count” is the total number of tokens in the primary sentence; each word or inline tag is counted as “1” and other types (number, token delimiter and punctuation marks) are not counted. Further, “total deductions” is a parameter that is described in detail below.

As noted above, sentences are made up of various elements referred to as “tokens”. In the inventive approach, there are token-level scoring rules that are applied in order to evaluate a comparison as between tokens that appear in two sentences—the primary sentence and the comparison sentence.

If token types are different, then the comparison rules apply a deduction of “1.0”. For token types that are the same, the comparison rules are as follows:
If two tokens are exactly the same, then deduction=0.0;
All tags are considered to be the same;
All numbers are considered to be the same;
For punctuation token types, deduction=0.3 if two tokens are different;
For delimiter token types, deduction=0.3 if two tokens are different;
For word token types, deduction=1.0 if two tokens are totally different, otherwise use partial match rules described just below; and
If two words differ only in capitalization, deduction=0.3

For character-based deductions or edit difference, scoring is calculated using the Levenshtein algorithm, which will be understood by those of skill in the art. For example, for two words: “kitten” and “sitting”, the numerical edit difference is “3”. For the pair of words “Saturday” and “Sunday”, the numerical edit difference is also “3”. Essentially then, given a pair of words, the edit difference is a way to define how different the words are—that is, the smaller the edit difference, the higher the similarity. An edit difference of “0” means that the words are identical.

As noted above, words can have partial matches. If two words, i.e. a primary word and a comparison word are different, but share enough similarity, such is defined as a “partial match.” There are partial match rules that are used to deduct partial credits. In the illustrated and described embodiment, there are two levels of partial matches, although any suitable number of partial match levels can be used without departing from the spirit and scope of the claimed subject matter. In point of fact, levels may not be used at all. For example, one approach could use the number of differences divided by the number of characters in the primary word. However, in this approach, the two levels of partial match are as follows:

70% partial match, with deduction=0.3

50% partial match, with deduction=0.5

In addition, there are two types of partial matches. Specifically, a first type exists in a substring case where one word is a substring of the other. A second type exists in non-substring cases where no substring relation exists for the word pair.

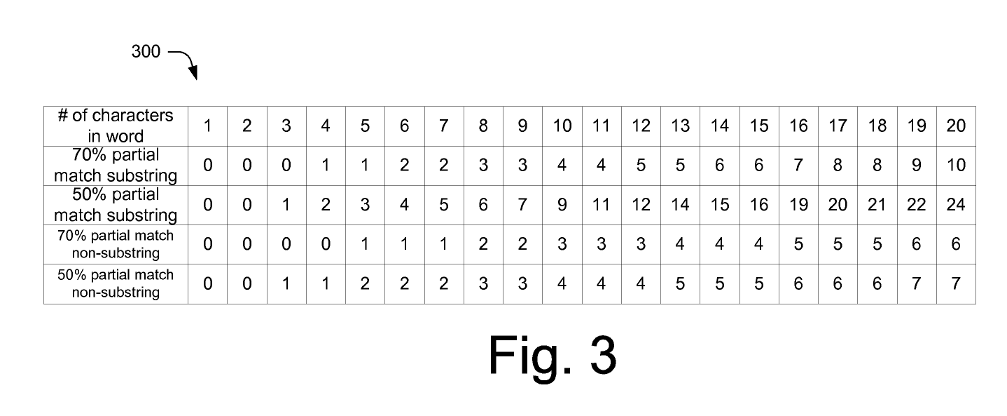

In the illustrated and described embodiment, the maximum allowable character difference varies with the total number of characters, partial match level, and partial match type. To simplify partial match calculations, some pre-calculated values can be used for word lengths of 1 to 20. If the length of the word exceeds 20, then the value for a length of 20 is used. As an example, consider FIG. 3 which illustrates a table 300 that defines an allowable character difference value for the various partial matches described above.

Having considered the notion of token-level scoring rules, consider now the notion of edit operations. When there are differences between the primary sentence and the comparison sentence, the way to account for the changes can, in many instances, be ambiguous or arbitrary. For example, if there is an extra word in the primary sentence, such can be accounted for by an insertion in the primary sentence, or a deletion in the comparison sentence. To reduce this kind of ambiguity and deduction differences applied to the final score, the following set of edit actions are used in score computation:
Insert—adding an extra token in the primary or the comparison sentence. No “deletion” is defined. Insertion is used to account for extra words, either inserts in the primary or the comparison sentence.
Change—one token on the primary sentence is replaced by a different token (of the same type) on the comparison sentence.
Move—the same token appeared at different relative positions in the primary and comparison sentence.

Recall that an overall score is calculated as follows:

Overall score=(total token count−total deductions)/(total token count)

“Total deduction” is the total deduction caused by all edit actions for all tokens on both primary and comparison sentences. Individual deductions are listed below:
Word change: 1.0
All other changes including inline tag, number, token delimiters, and punctuation marks: 0.3
Word insert: 0.9
Inline tag insert: 0.3
Number, token delimiter, or punctuation mark insert: 0.1
Move for all types: 0.3
70% partial word match: 0.3
50% partial word match: 0.5

In the illustrated and described embodiment, an insertion is counted as an individual edit action, whereas all other edit operations are pairs between primary and comparison sentences. In the event that the formula results in a negative score, a value of 0.0 can be used. Note that since we are interested in comparison sentences with high similarity to the primary sentence (so we can make use of the comparison sentences' translations), a threshold or bail-out value can be defined and used. Specifically, if in some way, we know the final score is likely to be below this “threshold”, then the calculation can be terminated to save time.

In the illustrated and described embodiment, a token class is used to store token values that are computed as described above and below. In the present example, a token class is defined as follows:
Token type: Word, Tag, Punctuation, Number, Delimiter;
Token value: the normalized string value of the token;
Original value: the original string value before normalization. This field is used by Tag and Number token types.
Match status: Inserted (default status), Matched, Matched70, Matched50, Changed, Moved;
Match position: the position of the matching counterpart on the other sentence, if the edit operation is not inserting. Even a “changed” token has a match position, so we know where the counterpart of this token is located in the other sentence.

This class is utilized because the sentence fuzzy matching described below utilizes multiple passes to complete. Later passes depend on the match properties from previous passes, and therefore match properties are stored by this token class.

Having considered a sentence-level scoring scheme and word-level score calculation, consider now a discussion of an example direct alignment algorithm in accordance with one or more embodiments.

Direct Alignment Algorithm

In the illustrated and described embodiment, a direct alignment algorithm is utilized to process primary and comparison sentences. From an algorithmic point of view, the problem constitutes what is known as a “longest common sequence” problem. This approach looks for the longest subsequence common to two sequences with the least amount of calculation. In the illustrated and described embodiment, a two-dimensional array is utilized to store edit differences for token pairs from primary and comparison token lists. This array is then utilized to determine a search direction and to identify aligned pairs, also referred to as “anchor points.”

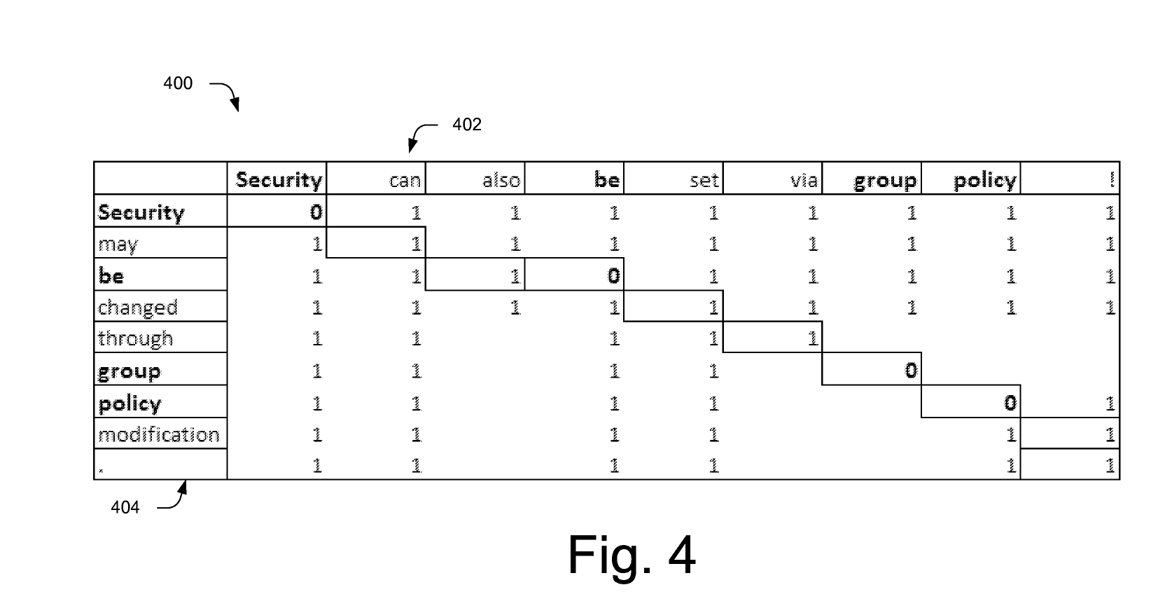

As an example of a two-dimensional array for an average case in which there are no partial word matches, consider FIG. 4. There, an example two-dimensional array is shown generally at 400. In this example, the array includes a primary sentence 402 and a comparison sentence 404. In this array, a “0” means that the token pair is identical; and, a “1” means that the token pair is totally different. Empty values are not evaluated. A path, illustrated by the boxes from the upper left corner of the array to the lower bottom corner of the array represents candidates of aligned token pairs or anchor points. Not all token pairs are used as anchor points.

In this example, the path defines horizontal, vertical, and single-pair groups. Specifically, by inspecting the path, one can see that there are neighboring cells with either the same vertical or horizontal indexes. These same vertical or horizontal indexes represent vertical groups or horizontal groups, respectively. One reason for introducing this concept is to be able to calculate the alignment in one pass, instead of two passes. The running total of difference values represents the sum of differences up to the current position. The benefit of being able to do the alignment in one pass is that if a threshold or bail-out value is defined, we can bail out of the calculation (to save time) based on the running total of differences.

In the illustrated and described embodiment, one horizontal or vertical group can have, at most, one aligned pair. If there is a difference value less than “1” in a group, then there is an aligned pair; if none of the values are less than “1” in a group, then there is no aligned pair. In at least some embodiments, a group can also have only one pair of tokens referred to as a single-pair group. As an example, consider the following:
Single-pair group: the pair from first token in primary sentence (top row) and first token in comparison sentence (left column), “security” vs. “security”, has value of 0; it is an aligned token pair.
Horizontal group: the third and fourth tokens in primary sentence and the third token in comparison sentence, “also” vs. “be” and “be” vs. “be”, there is one aligned pair (“be” vs. “be”).
Vertical group: the last token in primary sentence and last two tokens in the comparison sentence, “!” vs. “modification” and “!” vs. “.”, there is no aligned pair.

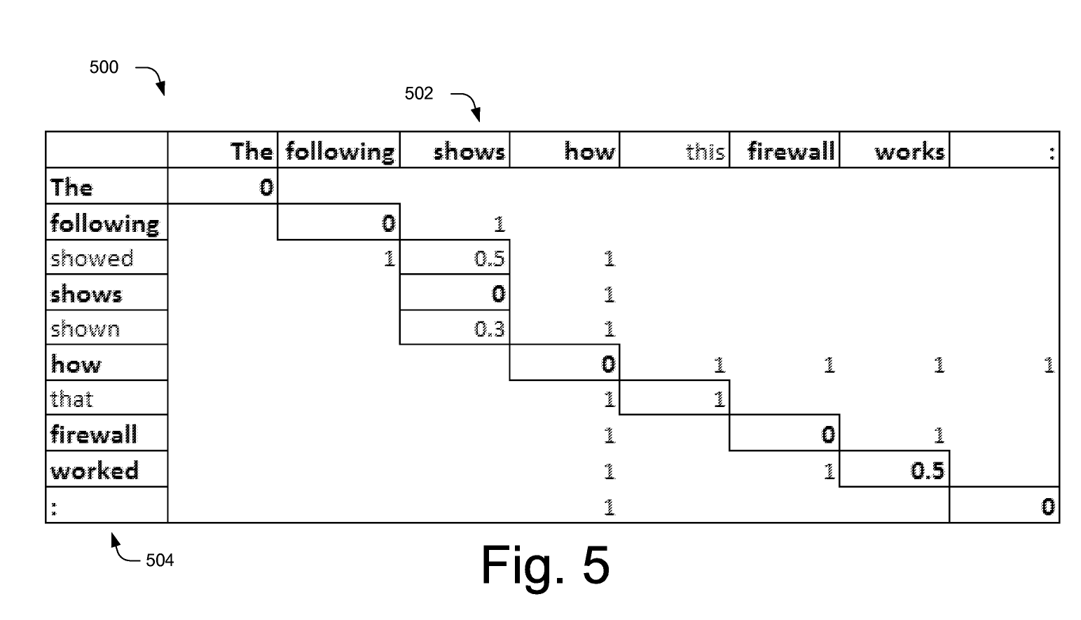

As an example of a two-dimensional array with partial word matches, consider FIG. 5 which shows an array in accordance with one or more embodiments generally at 500. In this example, the array includes a primary sentence 502 and a comparison sentence 504. In this array, a “0” means that the token pair is identical; and, a “1” means that the token pair is totally different.

A vertical group is defined by the third token in primary sentence and third through fifth tokens in comparison sentence, i.e., “shows” vs. “showed”, “shows” vs. “shows”, and “shows” vs. “shown”. All these three pairs have respective difference values less than 1.0. There is, however, only one aligned pair with the lowest difference value: “shows” vs. “shows”.

A single-pair group is defined by the pair from the second to the last token in primary sentence (top row) and the second to the last token in comparison sentence (left column), i.e, “works” vs. “worked”. This pair has a difference value of 0.5 and it is an aligned token pair. A path is shown that traverses from the upper left corner to the lower right corner. It is to be appreciated that a single-pair group can be anywhere with any difference values. For example, starting from the top left corner, “The” from the top row and “The” from the left column is a single-pair group; “following” from the top row and “following” from the left column is a single-pair group, so on.

Having described horizontal, vertical and single pair groups and various examples of two-dimensional arrays, consider now an example process that can be used to ascertain a path as described above.

Finding a Path with the Least Token-to-Token Comparison

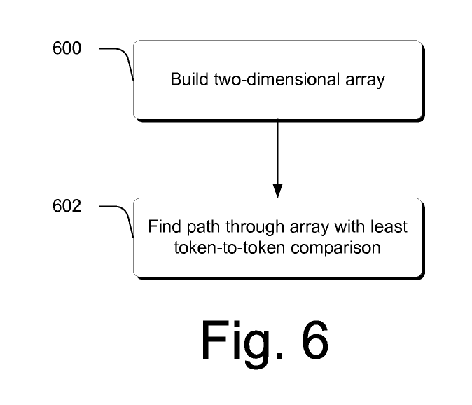

FIG. 6 is a flow diagram that describes, at a high level, steps in a method in accordance with one or more embodiments. The method can be implemented in connection with any suitable hardware, software, firmware or combination thereof. In at least some embodiments, the method can be implemented by a suitably configured translation memory system such as the one described above and below.

Step 600 builds a two-dimensional array that is to serve as a basis for token-to-token comparison between a primary sentence and a comparison sentence. Examples of two dimensional arrays are provided above. Step 602 finds a path through the array with the least token-to-token comparison.

In the discussion that follows, an implementation example is described that ties together the above discussion and illustrates how a final score can be calculated in accordance with one or more embodiments. The discussion just below serves as an embellishment of FIG. 6.

Main Algorithm—Implementation Example

Recall from the above discussion that the diagram of FIG. 2 describes an overall fuzzy matching algorithm in accordance with one or more embodiments. The discussion below provides an embellishment, from an implementation example standpoint, of one way in which the functionality described in FIG. 2 can be implemented. Individual sections appearing below map to individual steps described in FIG. 2. Such will be indicated in a corresponding section's header.

Token Initialization—Step 200 (FIG. 2)

In the illustrated and described embodiment, lists of token classes are initialized for the primary and comparison sentences. This includes setting an initial match status to “Inserted”. In addition, a two-dimensional array is built and initialized to “−1”, meaning that the values for the array have not yet been calculated.

In at least one example implementation, initialization includes the following operations. First, inline HTML or other markup tags are normalized—that is—all opening/closing HTML tags are abstracted to “<TAG>”. For example, “This is a <button>test</button>.” is normalized to “This is a <TAG> test <TAG>.” As another example, “This is <bold> another <underline> test </underline> </bold> with a <a href=“http://bing.com”> reference site</a>.” is normalized to “This is <TAG> another <TAG> test <TAG> <TAG> with a <TAG> reference site <TAG>.”

In addition, numbers occurring within the sentences are identified. The numbers may include commas “,” and periods “.”. Punctuation marks appearing within the sentences are processed, as are token delimiters. In the illustrated and described embodiment, this processing includes adding one space before and one space after all punctuation marks and delimiters. As an example, consider the following. Before processing, a sentence may appear as follows:
This is a test, and (another) test.

After processing, the sentence appears as follows:
This is a test , and ( another test ).

Steps downstream will split the sentence by spaces to create a token list.

Further, token classes are initialized, as noted above, by setting the match status to “Inserted”, and match position to “−1”.

The reason to initialize match status to “Inserted” is that “inserts” are the most expensive edit operation. That is, each token is counted for one insert from both the primary and comparison sentences, whereas other edit operations, such as “change” and “move”, consume two tokens.

Primary and Comparison Token List Alignment—Step 202 (FIG. 2)

Aspects of the direct alignment algorithm are described above. However, the following serves as an example of how a direct alignment algorithm can be performed to ascertain anchor points and match positions.

Preliminarily, a two-dimensional array is built, as illustrated above, and values associated with tokens are computed within the array. Any suitable method can be utilized to compute values associated with the tokens.

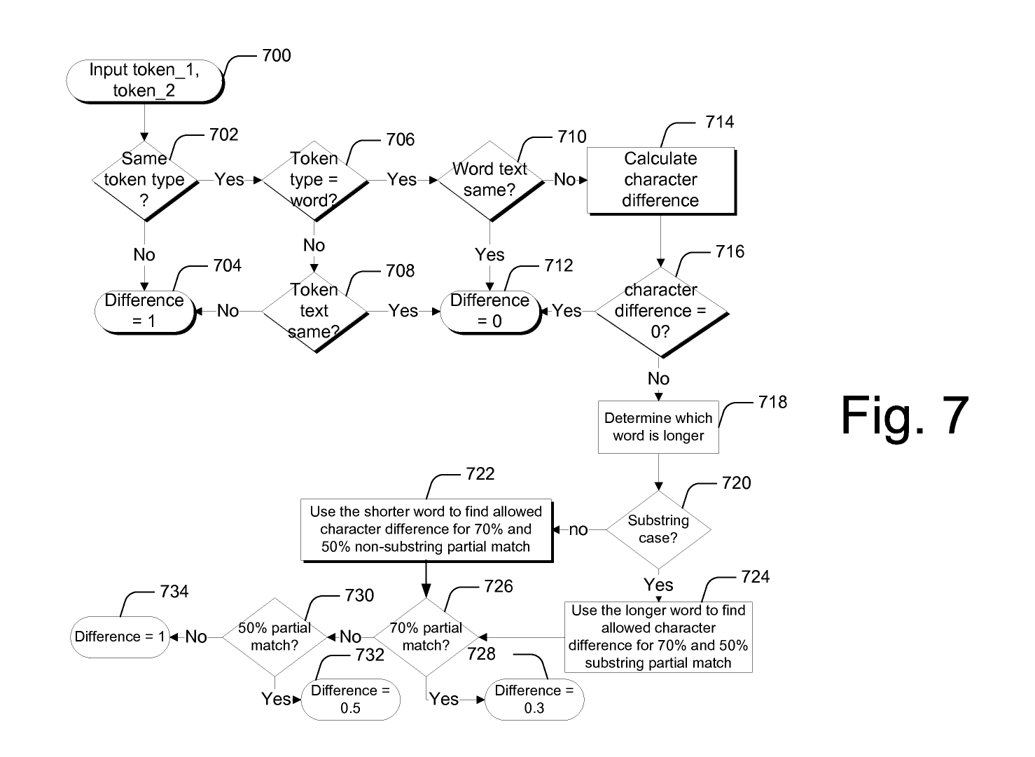

FIG. 7 illustrates a flow diagram that describes but one method for computing token differences for tokens that appear in the two-dimensional array in accordance with one embodiment.

Step 700 receives, as input, two tokens—one from the primary sentence and one from the comparison sentence. Step 702 ascertains whether the tokens are of the same type. If not, step 704 assigns a value of “1” for the token pair. If, on the other hand, the tokens are of the same type, step 706 ascertains whether the token type is a “word.” If not, step 708 ascertains whether the token text is the same. If not, the method returns to step 704 and assigns a value of “1”. If, on the other hand, step 708 ascertains that the token text is the same, step 712 assigns a value of “0” to the token pair.

If, at step 706, the token type is a “word” token type, step 710 ascertains whether the word text is the same. If the word text is the same, then step 712 assigns a value of “0” to the token pair. If, on the other hand, the word text is not the same, step 714 calculates a character difference. An example of character differences is described above in FIG. 3. If the character difference is ascertained, at step 716, to be “0”, then step 712 assigns a value of “0” to the token pair. If, on the other hand, the character difference is ascertained at step 716 to be a value other than “0”, step 718 determines which word is longer.

Step 720 determines whether the two tokens constitute a sub-string case. If not, step 722 uses the shorter word to find an allowed character difference for a 70% and a 50% non-substring partial match and proceeds to step 726 described below. If, on the other hand, step 720 ascertains that the tokens constitute a sub-string case, step 724 uses the longer word to find an allowed character difference for a 70% and 50% sub-string partial match.

If step 726 determines that there is a 70% partial match, step 728 assigns a value of 0.3 to the token pair. If, on the other hand, step 726 ascertains that there is not a 70% partial match, step 730 ascertains whether there is a 50% partial match as between the token pair. If there is a 50% partial match between the token pair, step 732 assigns a value of 0.5 to the token pair.

If there is not a 50% partial match, step 734 assigns a value of “1” to the token pair.

This process continues until the two-dimensional array has values computed for its associated token pairs.

After values have been assigned in the two-dimensional array, direct alignment processing can occur as described above. In the discussion that follows, the two-dimensional array can be characterized as a matrix[i,j], where i, j are indices of the matrix.

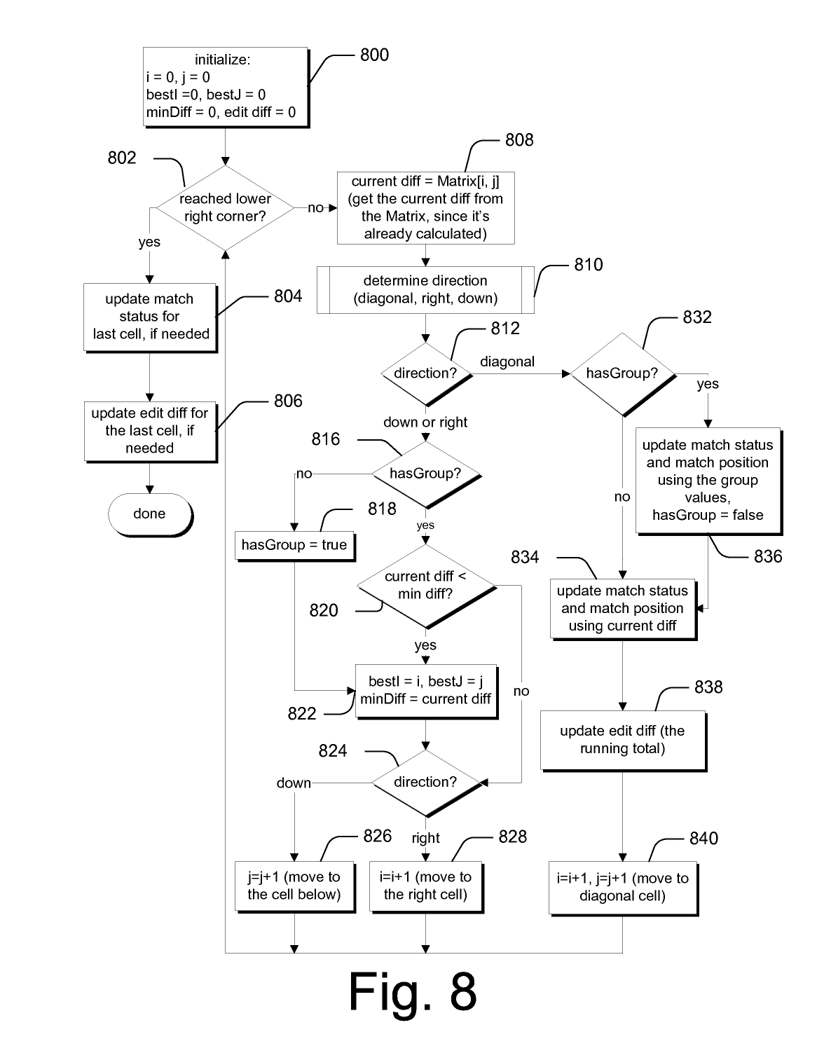

FIG. 8 is a flow diagram that describes the steps in a direct token alignment process in accordance with one or more embodiments. The process can be implemented in connection with any suitable hardware, software, firmware, or combination thereof. In at least some embodiments, the method can be implemented by a suitably-configured translation management system such as the one described above.

Step 800 is an initialization process in which the matrix indices are initialized to “0” to start the process at the upper left corner of the two-dimensional array or matrix. Further, bestI and bestJ parameters are initialized to “0”. These parameters correspond to the matrix cell with the lowest value in a match group. In the FIG. 5 example, when i=2 (corresponding to top row “shows”) and j=2 (corresponding to left column “showed”), bestI=2 and bestJ=2. After we move to the next cell, we find “shows” and “shows” is a better match, so the bestJ is updated to bestJ=3. After we moved to the next cell below, we did not find better match, so we would not update bestI and bestJ. After we finished this vertical group, we move to the next diagonal cell (i.e. “how” vs. “how”), and we initialize bestI=3, and bestJ=5.

Further, minDiff and edit diff parameters are set to “0”. “minDiff” is the minimum difference for a match group. Using the “shows” example in FIG. 5 again, “minDiff” was set to 0.5. When we moved to the next cell down, it was set to 0. However, it is not set to 0.3 when moved to the next cell below. “edit diff” is the running total value for the two sentences which, in at least some embodiments, can be used as a threshold for bailing out of the calculation if the “edit diff” exceeds a certain value.

Step 802 ascertains whether the lower right corner of the matrix has been reached. If so, 804 updates the match status for the last cell of the matrix and step 806 updates the edit difference and the processing is complete. If, on the other hand, the lower right corner of the matrix has not been reached at step 802, the parameter “current diff” is equal to matrix[i,j] at step 808. The “current diff” is the diff value for the current cell. Using the “shows” example in FIG. 5 again, when we first started, the current diff was 0. After we moved to the next cell (diagonal), current diff is still 0. Then we moved to the next cell (diagonal), and current diff was 0.5. When we moved to next cell down, current diff is 0, and when we moved to next cell down, current diff is 0.3. However, we do not update minDiff to 0.3.

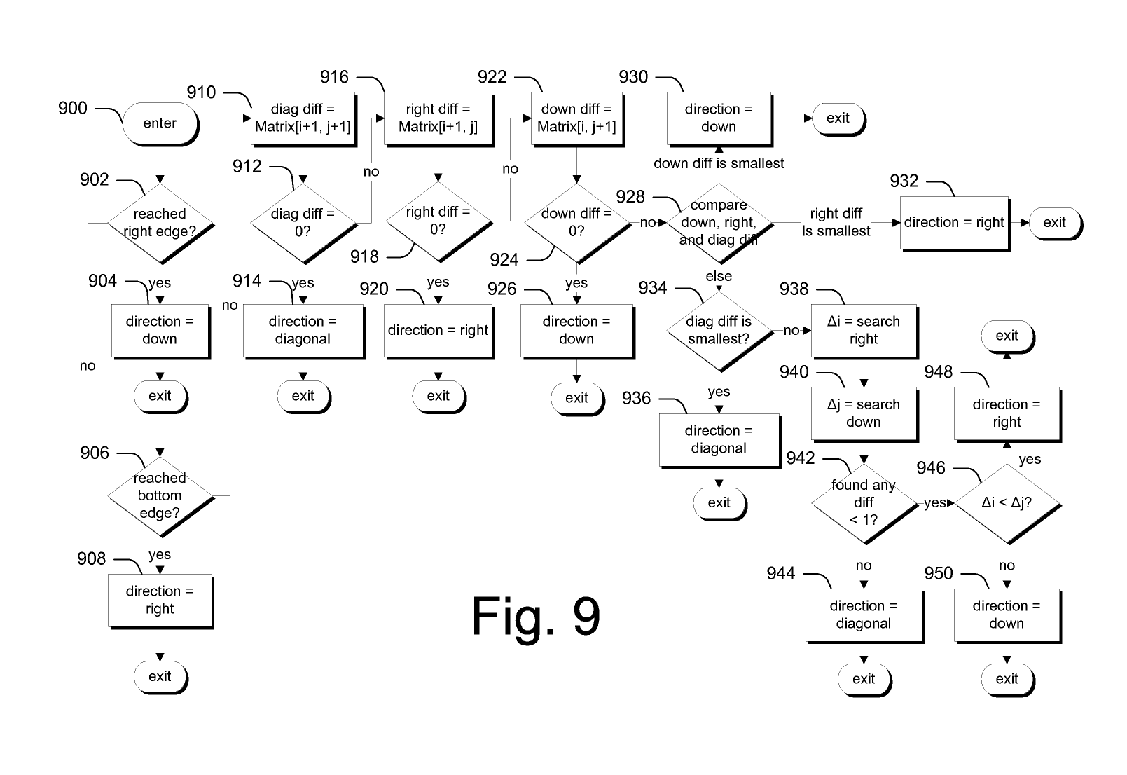

Step 810 determines a direction for a path from the upper left corner of the matrix to the lower right corner. One process for determining the direction of the path is described in connection with FIG. 9, just below. For purposes of continuity, however, the current description will continue, with a description of a process of search path determination following in connection with FIG. 9.

If the search direction is ascertained, at step 812, to be “down” or right, step 816 ascertains whether there is an associated group. With respect to the notion of a group, consider the following. We wish to complete the alignment in one pass as most other algorithms use two passes. Some of the diff values cannot be determined until we have moved to the next or further cells. Therefore, the notion of a group enables us to keep track of the intermediate values. When we move horizontally or vertically, we cannot tell the diff value until we are finished with the group, whereas with diagonal moves, we can safely assign a diff value as soon as we have moved out of the cell.

If step 816 determines that there is no associated group, step 818 sets a parameter hasGroup to ‘true” (thus starting a new group) and step 822 assigns bestI as i and bestJ as j, and the parameter minDiff is set equal to the value “current diff” (thus initializing values for the new group). If step 816 determines that there is an associated group, step 820 ascertains whether current diff is less than minDiff. If so, bestI is assigned as i and bestJ is assigned as j and minDiff is set equal to current diff and the process continues to step 824 to determine the direction. If, at step 820, the current diff is not less than minDiff, then the method branches to step 824. If at step 824 the direction is down, then step 826 increment j by 1 to move to the cell below. If the direction is determined to be right, then step 828 increments i by 1 to move to the right cell. After steps 826, 828, the method returns to step 802.

Returning to step 812, if the direction is determined to be diagonal, then step 832 ascertains whether there is an associated group. If so, step 836 updates the match status and match position using the group values and sets hasGroup to “false”. The method then continues to step 834. If step 832 ascertains that there is not an associated group, then the method branches to step 834.

Step 834 updates the match status and match position using current diff. Step 838 updates edit diff which is the running total referenced above. Step 840 then increments both i and j by 1 to move to a diagonal cell and the method returns to step 802.

Having considered steps in a direct token alignment process in accordance with one embodiment, consider now a discussion or embellishment of step 810 in which a search direction is ascertained. For this example, reference is made to FIG. 9.

FIG. 9 is a flow diagram that describes the steps in a process for determining search direction in accordance with one or more embodiments. The process can be implemented in connection with any suitable hardware, software, firmware, or combination thereof. In at least some embodiments, the method can be implemented by a suitably-configured translation management system such as the one described above.

Step 900 initiates a process for determining a search direction. Step 902 ascertains whether the right edge of the matrix has been reached. If so, the step 904 establishes the search direction as “down” and the routine exits and returns to step 812 in FIG. 8. If, on the other hand, step 902 ascertains that the right edge of the matrix has not been reached, step 906 ascertains whether the bottom edge of the matrix has been reached. If so, step 908 establishes the search direction as “right” and the routine exits to step 812 in FIG. 8. If, on the other hand, step 906 ascertains that the bottom edge of the matrix has not been reached, step 910 first ascertains the difference associated with a move in the diagonal direction. Step 912 ascertains whether the diagonal difference is equal to “0.” If so, step 914 establishes the search direction as “diagonal” and the routine exits to step 812 in FIG. 8. In the illustrated and described embodiment, the search direction algorithm attempts to proceed in the diagonal direction first.

If, on the other hand, the diagonal difference is not “0”, other directions are check for their differences. For example, step 916 ascertains the difference associated with a move in the “right” direction. Step 918 ascertains whether the right difference is equal to “0.” If so, step 920 establishes the search direction as “right” and the routine exits to step 812 in FIG. 8. If, on the other hand, step 918 finds that the right difference is not “0”, step 922 ascertains the difference associated with a move in the “down” direction. If step 924 determines that the difference in the down direction is “0”, step 926 establishes the search direction as “down” and the routine exits to step 812 in FIG. 8. If, on the other hand, step 924 determines that the difference in the down direction is not zero, step 928 compares the differences in the down, right, and diagonal directions. If the difference in the down direction is the smallest, the search direction is established as “down” at step 930, and the routine exits to step 812 in FIG. 8. If the difference in the right direction is the smallest, the search direction is established as “right” at step 932, and the routine exits to step 812 in FIG. 8.

If neither difference in the down or right direction is smallest, step 934 ascertains whether the difference in the diagonal direction is the smallest. If so, step 936 establishes the search direction as “diagonal” and the routine exits to step 812 in FIG. 8. If the difference in the diagonal direction is not the smallest, then collectively, steps 938-950 look to establish a search direction that selects a direction corresponding to the smallest difference of an adjacent cell in the matrix. If no smallest difference is found, for example if the differences in both the “down” and “right” directions are the same, then the search direction is established as “diagonal.” Thus, in at least some embodiments, a default direction is diagonal.

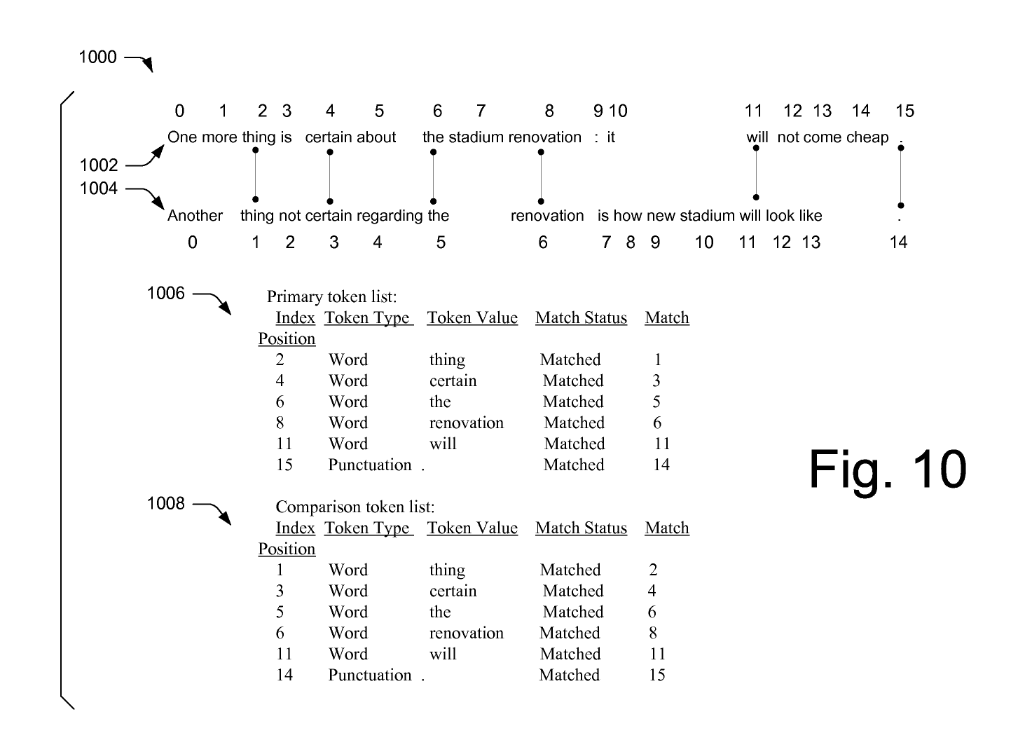

Consider now that the direct alignment process has been conducted for two sentences shown generally at 1000 in FIG. 10. There, a primary sentence 1002 and a comparison sentence 1004 are shown. Adjacent each sentence is a continuum of indices associated with individual tokens appearing in each sentence. After the direct alignment process has taken place, six anchor points have been identified by virtue of the processing described above. These anchor points are illustrated in FIG. 10 by the six lines connecting the same words or punctuation in the primary and comparison sentences. The anchor points are represented by data structures 1006 and 1008 for the primary and comparison sentences, respectively. The data structures list, for each anchor point in each of the primary and comparison sentences, an associated index value, a token type, a token value, a match status, and a match position. All of the other tokens have matched statuses of “inserted,” which is the default status, and a match position of “−1” meaning that there is no match. Having found the anchor points via the direct alignment process described above, consider now the effect of edit operations on the primary and comparison sentences.

Finding Changes—Step 204 (FIG. 2)

Since one change consumes two different tokens, the overall score will become higher if more “changes” are identified. However, changes can happen to a pair of tokens at the same “position” of the primary and comparison sentences. Here, “position” essentially means the relative position between anchor points, because absolute position cannot be used due to the insertion of tokens. If there are two different tokens at different “positions” of the primary and comparison sentence, such should be counted as two inserts instead of one change.

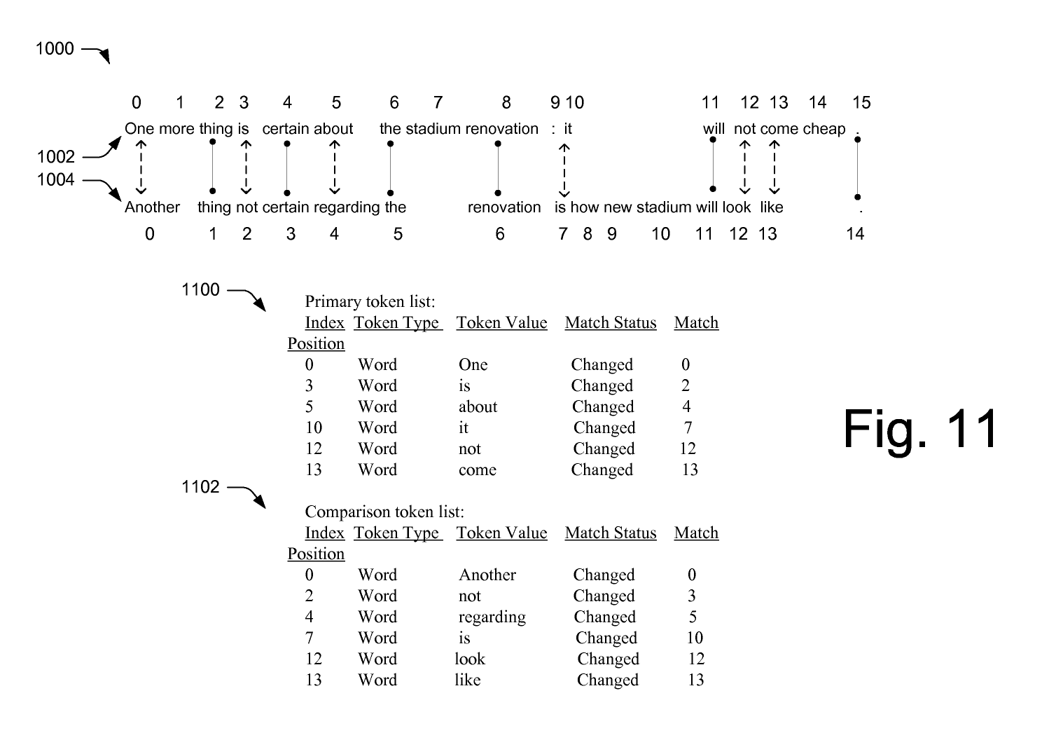

As an example, consider FIG. 11 which illustrates the two sentences 1002, 1004 of FIG. 10 generally at 1000. Here, there are six changes that have been identified which are indicated by the dashed/double-arrowed lines. These changes are represented in corresponding data structures shown at 1100, 1102 for the primary and comparison sentences, respectively. Each data structure lists, for each change, an associated index, token type, token value, match status, and match position.

Finding Moves—Step 206 (FIG. 2)

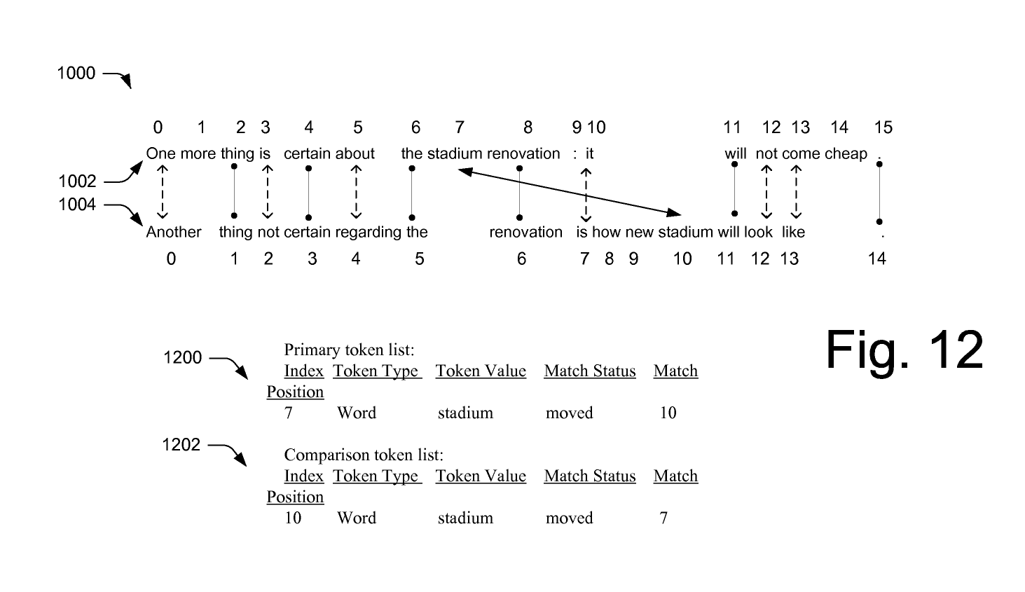

Finding “moves” can be a relatively straightforward process. Specifically, one can simply loop through all tokens with a default status of “inserted” at this point, and ascertain if there are matches on the comparison sentence. As an example, consider FIG. 12 which illustrates the two sentences 1002, 1004 of FIG. 10 generally at 1000. Here, one move is identified as indicated by the solid, double-arrowed line between the token “stadium.” “Moves” as between the primary and comparison sentences are represented by data structures 1200, 1202, respectively. These data structures list, for each move, an associated index, token type, token value, match status, and match position.

Adjusting Matched Status—Step 208 (FIG. 2)

In one or more embodiments, matched statuses can be optionally adjusted. One purpose for adjustments is to override the rules that have been established thus far. For example, assume we have primary and comparison sentences as below (each character is a WORD):
Primary sentence: A b c d e f.
Comparison sentence: A c x d e f.
According to our rules, there is one insert “b” at the primary sentence, and one insert “x” on the comparison sentence. Someone might have a special rule such as: if a pair of inserts happens on both primary and comparison sentences, and they share one common anchor point, they are a “Change” and “Move” pair (i.e., replace “b” with “x” and move to the other side of “c”).

Summing Deductions/Calculating the Final Score—Step 210 (FIG. 2)

Having computed, from the primary and comparison sentences, the alignment of the sentences along with various edit operations such as inserts, changes, and moves, one can now use the following sentence-level score formula to compute an overall score:

Overall score=(total token count−total deductions)/(total token count)

Using the above example, the relevant deductions are as follows:

(# of moves)*(move deduction)=1*0.3

(# of word changes)*(word change deduction)=6*1.0

(# of word inserts)*(word insert deduction)=4*0.9

(count inserts on both primary and comparison lists)

(# of punctuation inserts)*(punctuation insert deduction)=1*0.1

Total deduction=10.0

The total token count in the primary sentence, excluding punctuation is equal to “14.” Thus, using the overall score formula set forth above, the overall final score can be computed as follows:

(14−10)/14=29%

Thus, for this particular primary/comparison sentence pair, the overall score is a 29%. This can be used as a basis for comparison between other pairs comprised of the same primary sentence and different comparison sentences. The sentence pair with the highest overall final score can then be selected to facilitate translation of the primary sentence. Alternately or additionally, groups of sentence pairs having scores that fall within a particular range can be selected for further processing, as by a human translator.

Having considered an example fuzzy matching/scoring algorithm in accordance with one or more embodiment, consider now an example system that can be utilized to implement the embodiments described above.

Example System

FIG. 13 illustrates various components of an example device 1300 that can be implemented as any type of portable and/or computer device as described with reference to FIG. 1 to implement embodiments of a fuzzy matching/scoring algorithm as described herein. Device 1300 includes communication devices 1302 that enable wired and/or wireless communication of device data 1304 (e.g., received data, data that is being received, data scheduled for broadcast, data packets of the data, etc.). The device data 1304 or other device content can include configuration settings of the device, media content stored on the device, and/or information associated with a user of the device. Media content stored on device 1300 can include any type of audio, video, and/or image data. Device 1300 includes one or more data inputs 1306 via which any type of data, media content, and/or inputs can be received, such as user-selectable inputs, messages, music, television media content, recorded video content, and any other type of audio, video, and/or image data received from any content and/or data source. User-selectable inputs include one or more input mechanisms by which a user can interact with the device. A user-selectable input mechanism can be implemented in any suitable way, such as a keyboard, a button, a stylus, a touch screen, a mouse, voice input, and the like.

Device 1300 also includes communication interfaces 1308 that can be implemented as any one or more of a serial and/or parallel interface, a wireless interface, any type of network interface, a modem, and as any other type of communication interface. The communication interfaces 1308 provide a connection and/or communication links between device 1300 and a communication network by which other electronic, computing, and communication devices communicate data with device 1300.

Device 1300 includes one or more processors 1310 (e.g., any of microprocessors, controllers, and the like) which process various computer-executable or readable instructions to control the operation of device 1300 and to implement fuzzy matching and scoring as described above. Alternatively or in addition, device 1300 can be implemented with any one or combination of hardware, firmware, or fixed logic circuitry that is implemented in connection with processing and control circuits which are generally identified at 1312. Although not shown, device 1300 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1300 also includes computer-readable storage media 1314, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like.

Computer-readable media 1316 provides data storage mechanisms to store the device data 1304, as well as various device applications 1318 and any other types of information and/or data related to operational aspects of device 1300. For example, an operating system 1320 can be maintained as a computer application with the computer-readable media 1316 and executed on processor(s) 1310. The device applications 1318 can include a device manager (e.g., a control application, software application, signal processing and control module, code that is native to a particular device, a hardware abstraction layer for a particular device, etc.). The device applications 1318 also include any system components or modules to implement embodiments of a fuzzy matching/scoring algorithm. In this example, the device applications 1318 include a fuzzy matching/scoring module 1322 that is shown as a software module and/or computer application. The module 1322 is representative of software that is configured to implement the functionality described above. In addition, computer-readable media 1316 can include a translation memory database 1323 such as that described above.

Alternatively or in addition, the module 1322 can be implemented as hardware, software, firmware, or any combination thereof.

### CONCLUSION

Various embodiments provide a translation memory system that utilizes sentence-level fuzzy matching and a scoring algorithm based on direct alignment. In one or more embodiments, a fuzzy match scoring formula includes use of an edit operation definition to define various deductions that are computed as part of an overall score, an overall scoring algorithm, and word-level scoring and partial match definitions. A direct alignment algorithm finds a computed alignment between two sentences using a pair-wise difference matrix associated with a primary sentence and a comparison sentence. An overall algorithm identifies editing operations such as replacements, position swaps and adjustments for a final score calculation. Once final scores are calculated between the primary sentence and multiple comparison sentences, a primary/comparison sentence pair can be selected, based on the score, to serve as a basis for translating the primary sentence.

It is also to be appreciated and understood that the direct alignment algorithm described above can also be used in many other areas such as file comparison and the “longest common sequence” problem. For file comparison scenarios, if each sentence is treated as a token, the direct alignment algorithm can be used to find all the anchor points and then identify all the moved and changed tokens. Then, comparison results can be displayed.

To solve the “longest common sequence” problem, the direct alignment algorithm can be used to find all of the anchor points, thus ascertaining the longest common sequence.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
conducting a direct alignment operation to ascertain anchor points between a primary sentence for which a translation is sought and a comparison sentence for which a translation exists;
finding changes between anchor points in the primary and comparison sentences;
finding moves between the primary and comparison sentences, wherein changes and moves constitute deductions that are utilized to calculate a final score for the primary and comparison sentences; and
using the changes and the moves to calculate an overall score for the primary and comparison sentences.

2. The computer-implemented method of claim 1, wherein the primary and comparison sentences are comprised of tokens, wherein tokens comprise the following token types: word, tag, number, punctuation marks, or delimiter.

3. The computer-implemented method of claim 1, wherein conducting the direct alignment operation comprises utilizing a two-dimensional array to store edit differences for token pairs associated with the primary and comparison sentences, and at least to find said anchor points.

4. The computer-implemented method of claim 1, wherein conducting the direct alignment operation comprises utilizing a two-dimensional array to store edit differences for token pairs associated with the primary and comparison sentences, and at least to find said anchor points, wherein the two-dimensional array is configured to have entries associated with partial matches between the primary and comparison sentences.

5. The computer-implemented method of claim 1, wherein conducting the direct alignment operation comprises utilizing a two-dimensional array to store edit differences for token pairs associated with the primary and comparison sentences, and at least to find said anchor points, wherein the two-dimensional array is configured to have entries associated with partial matches between the primary and comparison sentences, and wherein the partial matches can comprise a 50% partial match or a 70% partial match between the primary and comparison sentences.

6. The computer-implemented method of claim 1, wherein conducting the direct alignment operation comprises:
utilizing a two-dimensional array to store edit differences for token pairs associated with the primary and comparison sentences, and at least to find said anchor points; and
finding a path from an upper left corner of the two-dimensional array to the lower right corner of the two-dimensional array, said path constituting a least token-to-token comparison.

7. The computer-implemented method of claim 1, wherein conducting the direct alignment operation comprises:
utilizing a two-dimensional array to store edit differences for token pairs associated with the primary and comparison sentences, and at least to find said anchor points; and
finding a path through the two-dimensional array, said path constituting a least token-to-token comparison, wherein a default direction for the path is a diagonal direction.

8. The computer-implemented method of claim 1, wherein using the changes and moves to calculate an overall score comprises calculating an overall score in accordance with the following formula:
Overall score=(total token count—total deductions)/(total token count),
where “total token count” is the total token count for the primary sentence and “total deductions” takes into account at least the number of moves and the number of changes.

9. The computer-implemented method of claim 1, wherein using the changes and moves to calculate an overall score comprises calculating an overall score in accordance with the following formula:
Overall score=(total token count−total deductions)/(total token count),
where “total token count” is the total token count for the primary sentence and “total deductions” takes into account at least the number of moves, the number of changes, word inserts and punctuation inserts.

10. The computer-implemented method of claim 1, wherein the primary and comparison sentences both comprise English sentences.

11. One or more computer readable storage media embodying computer readable instructions which, when executed, implement a method comprising:
building a two-dimensional array that is to serve as a basis for token-to-token comparison between a primary sentence for which a translation is sought and a comparison sentence for which a translation exists, wherein the two-dimensional array includes individual values associated with matches between tokens of the primary and comparison sentences; and
finding a path through the array with a least token-to-token comparison, wherein said path defines one or more anchor points between tokens of the primary and comparison sentences.

12. The one or more computer readable storage media of claim 11, wherein tokens comprise one of the following token types: word, tag, number, punctuation marks, or delimiter.

13. The one or more computer readable storage media of claim 11, wherein the two-dimensional array is configured to have entries associated with partial matches between the primary and comparison sentences.

14. The one or more computer readable storage media of claim 11 further comprising finding one or more changes between anchor points in the primary and comparison sentences and assigning deductions for any found changes.

15. The one or more computer readable storage media of claim 11 further comprising finding one or more moves between the primary and comparison sentences, and assigning deductions for any found moves.

16. The one or more computer readable storage media of claim 11 further comprising calculating an overall score for the primary and comparison sentences in accordance with the following formula:
Overall score=(total token count−total deductions)/(total token count),
where “total token count” is the total token count for the primary sentence and “total deductions” takes into account deductions associated with edit actions between the primary and comparison sentences.

17. The one or more computer readable storage media of claim 11 further comprising calculating an overall score for the primary and comparison sentences in accordance with the following formula:
Overall score=(total token count−total deductions)/(total token count),
where “total token count” is the total token count for the primary sentence and “total deductions” takes into account deductions associated with edit actions between the primary and comparison sentences, wherein edit actions include insert actions.

18. The one or more computer readable storage media of claim 11 further comprising calculating an overall score for the primary and comparison sentences in accordance with the following formula:
Overall score=(total token count−total deductions)/(total token count),
where “total token count” is the total token count for the primary sentence and “total deductions” takes into account deductions associated with edit actions between the primary and comparison sentences, wherein edit actions include insert actions, wherein edit actions include change actions.

19. The one or more computer readable storage media of claim 11 further comprising calculating an overall score for the primary and comparison sentences in accordance with the following formula:
Overall score=(total token count−total deductions)/(total token count),
where “total token count” is the total token count for the primary sentence and “total deductions” takes into account deductions associated with edit actions between the primary and comparison sentences, wherein edit actions include insert actions, wherein edit actions include move actions.

20. The one or more computer readable storage media of claim 11 further comprising calculating an overall score for the primary and comparison sentences in accordance with the following formula:
Overall score=(total token count−total deductions)/(total token count),
where “total token count” is the total token count for the primary sentence and “total deductions” takes into account deductions associated with edit actions between the primary and comparison sentences, wherein edit actions include insert actions, wherein edit actions include insert actions, change actions and move actions.
